(19) United States
(12) Patent Application Publication
(10) Pub. No.: US 2006/0014623 A1
(43) Pub. Date: Jan. 19, 2006

(54) High thermal conductivity AIN-SiC composite artificial dielectric material

(76) Inventor: Biljana Mikijelj, Cerritos, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/892,720

(22) Filed: Jul. 15, 2004

(51) Int. Cl. C04B 35/577; C04B 35/582

(52) U.S. Cl. 501/92; 501/98.6

(57) ABSTRACT

Dense composites of dielectric material having high thermal conductivity and adjustable dielectric properties. The dense composites are composed of homogeneous mixtures of AlN and SiC with at least one member selected from the group consisting of Y₂O₃, La₂O₃, rare earth oxides, CaO and Li₂O. These composites are ideally shaped into usable products such as traveling wave tubes and electronic accelerators for use in microwave environments.

### TECHNICAL FIELD OF INVENTION

The present invention deals with dense composites of dielectric material having high thermal conductivity and adjustable dielectric properties. The dense composites comprise homogenous mixtures of AlN and SiC with at least one member selected from the group consisting of Y₂O₃, La₂O₃, rare earth oxides, CaO and Li₂O.

### BACKGROUND OF THE INVENTION

It is known that AlN—SiC dense composites have characteristically high dielectric constants and loss tangents in the 1-15 GHz (and higher) range of the electromagnetic radiation spectrum which is where microwave frequencies can be found. Relying upon these characteristics, AlN—SiC dense composites are usable as microwave absorbers in traveling wave tubes and electron accelerators and in other applications where microwave attenuation is required. However, use of such dense composites is restricted in cases where the amount of microwave energy absorbed is high and high material thermal conductivity is required. In such instances, BeO based dielectrics have been used notwithstanding their known toxicity.

It is thus an object of the present invention to provide artificial dielectric composites configurable into useful objects such as microwave absorbers in traveling wave tubes and electron accelerators while avoiding the toxicity characteristics of BeO based prior art dielectrics.

It is yet a further object of the present invention to provide useful objects composed of dense AlN—SiC composite dielectrics which are particularly of benefit in microwave environments where the amount of microwave energy absorbed is high and high material thermal conductivity is required.

These and further objects of the present invention will be more readily appreciated when considering the following disclosure and appended claims.

### SUMMARY OF THE INVENTION

The present invention is directed to dense composites of dielectric material having high thermal conductivity and adjustable dielectric properties. The dense composites comprise a substantially homogeneous mixture of AlN and SiC with at least one member selected from the group consisting of Y₂O₃, La₂O₃, rare earth oxides, CaO and Li₂O.

The present invention is also directed to a method of producing a shaped part of a dense composite of dielectric material of AlN and SiC combined with at least one member selected from the group consisting of Y₂O₃, La₂O₃, rare earth oxides, CaO and Li₂O. The method comprises homogeneously mixing the dielectric material and shaping the dielectric material either in a dry form or in the form of a slurry to produce the shaped part.

### BRIEF DESCRIPTION OF DRAWINGS

FIG. 1 represents the relationship between thermal conductivity of the dense dielectric composites of the present invention with that of prior art materials.

FIG. 2 represents a graphical comparison of the dielectric constants of the dense composites of dielectrical material of the present invention as compared with the prior art.

FIG. 3 represents a graphical representation of the loss tangent of lossy materials in comparing the dense composites of dielectric material of the present invention with that of the prior art.

### DETAILED DESCRIPTION OF THE INVENTION

As noted, AlN—SiC dense composites characteristically have high dielectric constants and loss tangents in the 1-15 GHz (and higher) range of the electromagnetic radiation spectrum which is that portion of the spectrum characterized as having microwave frequencies. These properties allow such materials to be used as microwave absorbers in traveling wave tubes, electron accelerators and in other applications where microwave attenuation is required. Its use is restricted, however, in cases where the amount of microwave energy absorbed is high and high material conductivity is required. BeO based dielectrics have been used in such cases despite their toxicity.

The present invention which comprises producing a shaped part of a dense composite of dielectric material of AlN and SiC represents the recognition that small additions of Y₂O₃, La₂O₃, rare earth oxides, CaO and Li₂O and mixtures thereof increase the thermal conductivity of AlN—SiC composites by a minimum of 50% over composites without these additions. Further, thermal conductivity characteristics are improved in the practice of the present invention.

More specifically, attention is directed to Table 1 listing measured thermal conductivities on hot presses of AlN—40% SiC composites:

TABLE 1
Thermal Conductivities Measured on Hot Presses AIN/40% SiC Materials

| | Thermal Conductivity | Relative Density |
|---|---|---|
| Sintering Aids | (W/mK) | (% Theoretical) |
| none (standard | 28 | 99.8 |
| composition) | | |
| 0.5% CaO | 45.1 | 96.0 |
| 1.0% CaO | 45.0 | 98.6 |
| 0.5% CaO + 0.5% Y₂O₃ | 43.4 | 99.0 |
| 0.5% Y₂O₃ | 53.4 | 99.5 |
| 1.0% Y₂O₃ | 54.3 | 99.5 |
| 1.5% Y₂O₃ | 54.4 | 99.5 |
| 3.0% Y₂O₃ | 64.4 | 99.3 |
| 5.0% Y₂O₃ | 56.0 | 99.4 |

As noted from the above, thermal conductivities are dramatically improved when CaO and particularly Y₂O₃ is added to the dense dielectric mixture.

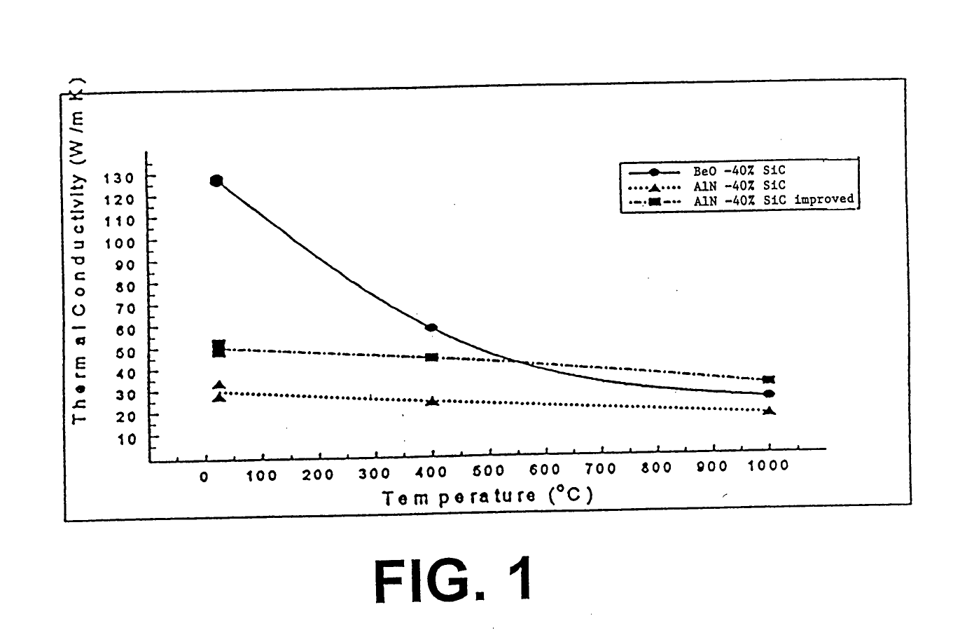

In order to further substantiate the present invention, reference is made to FIG. 1 where thermal conductivity of the dense composites of dielectric material was measured as a function of temperature. Although, at low temperatures, the composite of BeO—40% SiC exhibited higher thermal conductivity than either AlN—40% SiC or AlN—40% SiC with Y₂O₃, in all instances, the latter showed increased thermal conductivity over AlN—40% SiC without the Y₂O₃ addition. Further, as temperatures increased, the composite of the present invention demonstrated improved thermal conductivity even as compared to the BeO—40% SiC composite while not having any of the toxicity characteristics inherent in the use of a BeO containing material.

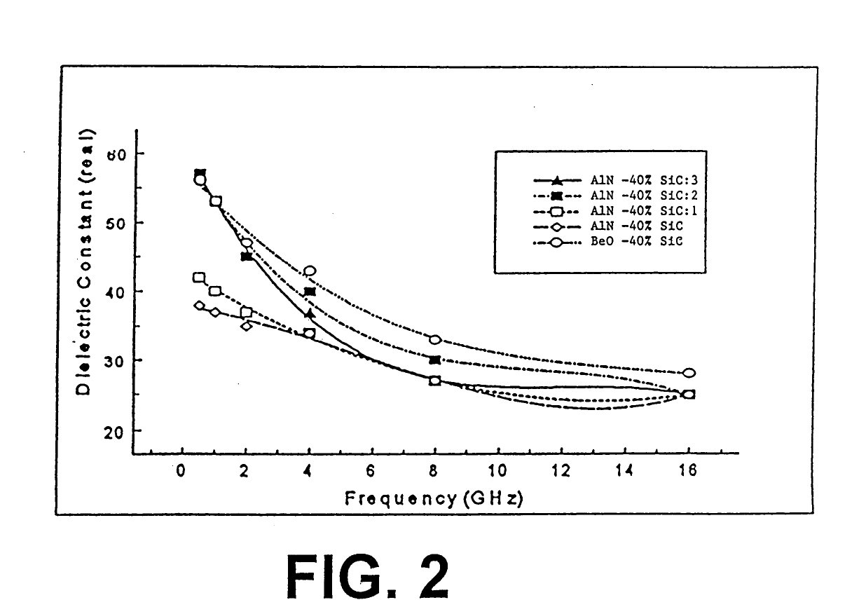

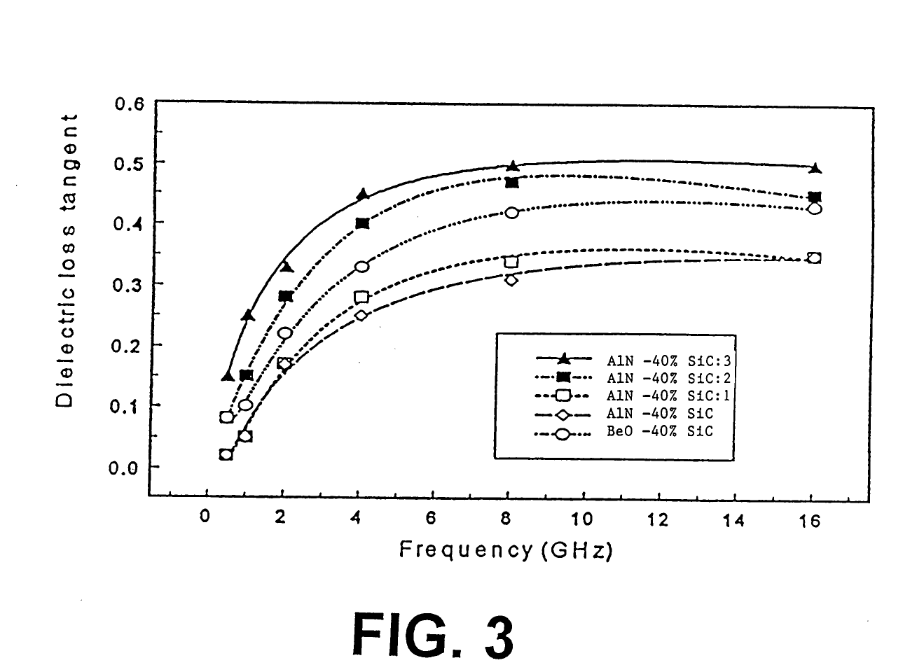

To further illustrate the improved nature of the present invention, reference is made to FIGS. 2 and 3 which amply demonstrate the dielectric constants and losses as a function of frequency measured in GHz and that they can be adjusted by varying the amount of Y₂O₃. As FIG. 3 amply demonstrates, the dielectric loss tangent of the composite AlN—40% SiC with 0.5, 1.0 and 1.5% Y₂O₃ compares favorably with the composite BeO—40% SiC while, again, avoiding the characteristic toxicity which any BeO-containing material displays.

It is contemplated that the present composition contain from approximately 20.0 to 99.7% by weight AlN, approximately 0.2 to 80.0% by weight SiC and approximately 0.1 to 6.0% by weight of a member selected from the group consisting of Y₂O₃, La₂O₃, rare earth oxides, CaO and Li₂O or a combination thereof. Useful objects such as microwave absorbers and traveling wave tubes and electron accelerators can be produced by combining the various ingredients in a process of hot pressing, hipping, and sintering either under gas pressure or in a pressureless (including microwave sintering) system. The various powders can be homogeneously mixed using conventional ceramic powder batching techniques such as ball milling, combining dry or in a slurry or employing a spray drying technique. In case of slurry mixing, an appropriate solvent is used, such as an alcohol, hexane or similar solvent to prevent hydrolysis of the AlN powder. Binders can be added to the powder during mixing as necessary. Such binders include PVA, PEG, acrylic binders or others known in the art. Parts can be formed using standard powder consolidation techniques such as by dry pressing, isopressing, slip casting, tape casting and gel casting. The final, dense materials are obtained by the simultaneous application of heat and pressure to the parts or by only heating the parts in a non-oxidizing, inert atmosphere such as argon and nitrogen. The sintering temperature ranges between 1500 and 2000° C. and preferably between 1700 and 1900° C. Articles produced by the present composition are characterized as having high thermal conductivity, adjustable dielectric properties, high hardness and high toughness. Such products are capable of absorbing microwave energy and display enviable wear resistant characteristics.

### EXAMPLE 1

Commercially available AlN (1 m²/g), SiC (3 m²/g), Y₂O₃ (10 m²/g) and CaCO₃ (10 m²/g) were mixed to yield a ratio of 40% SiC, 0.5% Y₂O₃, 0.5% CaO and remainder of AlN (% by weight) after firing. The powder was homogenized in one case by dry milling in a ball mill jar with SiC media, and in another using isopropyl alcohol based slurry and a high shear mixer. The isopropyl slurry powder batch was then dried, and the powder was collected and screened. The collected powders was pressed in a 4″×4″ steel die to form a billet. The billets were then assembled into a graphite tooled hot-press die, and placed into a hot press. The billets were heated in the furnace to 1400° C. with only 500 psi pressure applied to the die. 2500 psi pressure was slowly applied to the die between 1400 and 1600° C. The material was then heated to 1950° C. and held at that temperature for 30-90 minutes. Power and pressure were turned off, the furnace cooled and the billets taken from the tooling. The billet densities were 99.1% of theoretical, and the termal conductivity was measured to be 45 W/mK. Material mixed in slurry form exhibited a more uniform microstructure.

### EXAMPLE 2

Commercially available AlN (1 m²/g), SiC (3 m²/g) and Y₂O₃ (10 m²/g) were mixed to yield a ratio of 40% SiC, 3 and 5% Y₂O₃ and remainder of AlN (% by weight) after firing. The powder was homogenized using isopropyl alcohol based slurry and a high shear mixer, with the addition of alcohol soluble binder. The isopropyl slurry powder batch was then dried, and the powder was collected and screened. The collected powders were pressed in a 4″×4″ steel die to form a billet, followed by a burn-out operation at 350° C. The billets were then assembled into a graphite tooled hot-press die, and placed into a hot press. The billets were heated in the furnace to 1400° C. with only 500 psi pressure applied to the die. 2500 psi pressure was slowly applied to the die between 1400 and 1700° C. The material was then heated to 1850° C. and held at that temperature for 120 minutes. Power and pressure were turned off, the furnace cooled and the billets taken from the tooling. The billet densities were 99.5% of theoretical, and the thermal conductivity was measured to be 65 W/mK (3% Y₂O₃) and 56 W/mK (5% Y₂O₃).

### EXAMPLE 3

Commercially available AlN (1 m²/g), SiC (3 m² μg), Y₂O₃ (10 m² μg) and Li₂O (3 m²/g) were mixed to yield a ratio of 40% SiC, 1% Y₂O₃, 1% Li₂O and remainder of AlN (% by weight) after firing. The powder was homogenized using isopropyl alcohol based slurry and a high shear mixer. The isopropyl slurry powder batch was then dried, and the powder was collected and screened. The collected powders were pressed in a 4″×4″ steel die to form a billet. The billets were then assembled into a graphite tooled hot-press die, and placed into a hot press. The billets were heated in the furnace to 1400° with only 500 psi pressure applied to the die. 2500 psi pressure was slowly applied to the die between 1400 and 1600° C. The material was then heated to 1900° C. and held at that temperature for 30-90 minutes. Power and pressure were turned off, the furnace cooled and the billets taken from the tooling. The billet densities were 99.4% of theoretical, and the thermal conductivity was measured to be 42 W/mK.

### EXAMPLE 4

Commercially available AlN (8 m²/g), SiC (3 m²/g) and Y₂O₃ (10 m²/g) were mixed to yield a ratio of 40% SiC, 5% Y₂O₃ and remainder of AlN (% by weight). The powder was homogenized using isopropyl alcohol based slurry by ball milling. The isopropyl slurry powder batch was then dried, and the powder was collected and screened. The collected powder was pressed in a 1.34″ steel die to form pellets. The pellets were then heated in a graphite crucible in a nitrogen atmosphere furnace to 1950° and held at that temperature for 30-90 minutes. The billet densities were 97.1% of theoretical, and the thermal conductivity was measured to be 45 W/mK.

I claim:

1. Dense composites of dielectric material having high thermal conductivity and adjustable dielectric properties, said dense composites comprising a substantially homogeneous mixture of AlN and SiC with at least one member selected from the group consisting of Y₂O₃, La₂O₃, rare earth oxides, CaO and Li₂O

2. The dense composites of claim 1 wherein said AlN is present in said dense composites in an amount between approximately 20.0 to 99.7% by weight.

3. The dense composites of claim 1 wherein said SiC is present in said dense composites in an amount between approximately 0.2 to 80.0% by weight.

4. The dense composites of claim 1 wherein said member selected from the group consisting of Y₂O₃, La₂O₃, rare earth oxides, CaO and Li₂O is present in said dense composites in an amount between approximately 0.1 to 6.0% by weight.

5. A method of producing a shaped part composed of a dense composite of dielectric material of AlN and SiC combined with at least one member selected from the group consisting of Y₂O₃, La₂O₃, rare earth oxides, CaO and Li₂O, said method comprises homogeneously mixing said dielectric material and shaping said dielectric material into a shape of said shaped part followed by substantial simultaneous application of heat and pressure.

6. The method of claim 5 wherein said simultaneous application of heat and pressure is conducted employing a process selected from the group consisting of hot pressing, hipping, gas pressure sintering and pressureless sintering, said sintering being carried out at temperatures between approximately 1500 to 2000° C.

7. The method of claim 5 wherein said process of homogeneous mixing comprises ball milling said dielectric material dry or in a solvent to form a slurry without hydrolysis of the AlN.

8. The method of claim 7 wherein said solvent comprises an alcohol.

9. The method of claim 5 wherein said dielectric material is shaped into a part by a process selected from the group consisting of dry pressing, isopressing, slip casting, tape casting and gel casting.

10. The method of claim 5 wherein said shaped part comprises a microwave absorber in a traveling wave tube.

11. The method of claim 5 wherein said shaped part is a microwave absorber in an electron accelerator.
